(19) United States
(12) Patent Application Publication
(10) Pub. No.: US 2012/0103864 A1
(43) Pub. Date: May 3, 2012

(54) INTEGRATED PACKING AND SHIPPING MATERIALS WITHIN SERVERS AND DATA STORAGE MACHINES

(75) Inventors: Edward J. Grenchus, JR., Vestal, NY (US); Stephan G. Laforge, Seine (FR)

(73) Assignee: INTERNATIONAL BUSINESS MACHINES CORPORATION, Armonk, NY (US)

(21) Appl. No.: 12/917,777

(22) Filed: Nov. 2, 2010

(51) Int. Cl. B65D 85/00; B65D 81/02; B23P 17/04; B65D 85/30

(52) U.S. Cl. 206/701; 206/591; 206/523; 206/522; 29/428

(57) ABSTRACT

Various techniques and designs for integrating protective packaging and shipping material within large objects such as computer systems are disclosed herein. This protective material, when exposed, allows the object it is coupled with to be safely transported and shipped. In one embodiment applicable to large machines such as computer mainframes, a protective shock-absorbent material such as foam is affixed to a first face of a reversible machine cover. The machine cover may be oriented to insert and hide the protective material within the machine and expose a cover on the second face. The cover then may be placed in a reverse orientation to expose the protective material on the first face. In this way, the protective material does not need to be separately stored or provided to the customer before transport. Further, the protective material is kept in a convenient location with the machine, and when deployed will provide shock protection according to original manufacturer specifications.

### FIELD OF THE INVENTION

The present invention generally relates to the integration of protective packaging and shipping materials within objects. The present invention more specifically relates to techniques and structures for deploying integrated protective materials within objects such as large computer servers and data storage machines to enable their safe shipping and transport.

### BACKGROUND OF THE INVENTION

High end information technology machines (such as mainframe servers and large data storage systems) that are shipped to clients are typically packaged with protective packing and packaging materials to prevent damage during transport from the manufacturer or distributor to the customer. Upon arrival at the shipping destination, the machines are unpacked and the protective packing or packaging material is usually discarded because the customer does not have sufficient storage space to retain the material.

Failure to keep the correct fitting protective material creates a problem especially for machines that need to be returned to a center for servicing or are involved in leasing arrangements and must be returned to the manufacturer at the end of the lease. Because the proper protective materials have been discarded by the customer, the returned machines are often damaged in shipment.

Many types of shipping containers and packaging materials are well known and widely used. However, existing materials and techniques utilize shipping containers and protective packaging that are separate from the product to be shipped.

### BRIEF SUMMARY OF THE INVENTION

One aspect of the present invention relates to techniques and structures that integrate packaging material with the machine or object which is being transported. This eliminates the need for retaining the packaging material separately from the machine or object, and the eventual problems caused by discarded or lost packing material. Further, with integration of the presently described materials and structures, the original protective materials that satisfy the product manufacturer's specifications and design may be always accessible and available for reuse.

In one embodiment disclosed herein, packing and protective material is integrated into one or more components of a machine or product through the use of reversible covers configured to be operably coupled to the machine or product. For example, in connection with a mainframe computer system, the protective material may be attached to a series of reversible covers that are removably attached to the mainframe chassis of the computer system. The packaging material is affixed to a first side of the reversible cover that is exposed during transport, with the second side of the reversible cover being exposed during normal operation and providing an aesthetic cover to the computer system. The packaging material and the first side of the cover will remain stored internally within the computer system when not needed. The cover may be flipped to expose the affixed packaging material externally to again serve as shipping protection when needed.

In one specific embodiment disclosed herein, a computer mainframe assembly with integrated packaging comprises a frame structured for support of a plurality of computer system components, and at least one reversible cover panel with protective material disposed on one side of each cover panel. The exterior of the frame is defined by a plurality of support members, and the space within the interior of the support members defines an interior cavity within the frame. The computer system components are correspondingly coupled to the frame and arranged within this interior cavity.

Each reversible cover panel is structured to be removably coupled to the exterior of the frame. The cover panel may be a thin metal product, although it may also comprise a variety of other compositions such as hardened plastic. As suggested, one side (the first side) of the cover panel has the protective material disposed on or attached to it. The opposite side (the second side) of the cover panel may provide an aesthetic cover that is exposed during normal operation of the computer system. When the first side of the cover panel is coupled to the exterior of the frame, the protective material is positioned entirely within the interior cavity of the frame and may be hidden. When the second side of the cover panel is coupled to the exterior of the frame, the protective material is exposed and extends distally to the frame, which allows the protective material to be exposed during transport. The protective material may be a solid piece of packaging material, or may comprise a series of spaced-apart packaging material units.

Another specific embodiment described herein provides a product having integrated protective packaging material with a product frame defining an internal cavity, a plurality of reversible covers, and protective packaging material disposed on one side of each reversible cover, wherein the reversible cover may be removably coupled to the exterior of the product frame to either expose the protective packaging material or hide the protective packaging material within the internal cavity in accordance with the techniques described herein.

Still another specific embodiment described herein provides a method of integrating protective packaging material within a product assembly, comprising the steps of attaching a protective packaging material to a first side of a reversible cover panel, mounting the reversible cover panel to the product assembly to expose the first side of the reversible cover panel and the protective packaging material, removing the reversible cover panel from the assembly, recessing the protective packaging material within an interior cavity of the product assembly, and mounting the reversible cover panel to the product assembly to hide the first side of the reversible cover panel and the protective packaging material.

### BRIEF DESCRIPTION OF THE DRAWINGS

FIG. 1 provides an illustration of integrated packaging material deployed within a mainframe computer system chassis according to an embodiment of the present invention;

FIG. 2 provides an illustration of integrated packaging material attached to a cover of a computer system for placement within an interior recess of a machine frame according to an embodiment of the present invention;

FIG. 3 provides an illustration of integrated packaging material attached to a cover of a computer system for placement to the exterior of the machine frame according to an embodiment of the present invention; and

FIG. 4 provides another illustration of integrated packaging material attached to a cover of a computer system according to an embodiment of the present invention.

### DETAILED DESCRIPTION OF THE INVENTION

Various techniques and structures for integrating packaging material with objects to facilitate safer shipping are disclosed herein. In one embodiment deployed in connection within a large computer system, a set of protective packaging may be coupled to a first side of a reversible cover and integrated into the interior recesses of the computer system frame. The second side of the reversible cover may be normally exposed and provide an aesthetic cover to the computer system. When the computer system needs to be transported, an operator may reverse the cover to expose the first side and the coupled protective packaging. Accordingly, the integrated packaging material when exposed will provide protection and reduce the incidence or amount of damage to the computer system during transport.

Numerous advantages of the presently disclosed techniques and structures will be apparent from the following description. The use of properly shaped and sized protective material in a return shipping process will reduce exterior surface damage to the machine (and possibly even prevent or reduce interior damage to electronic or other sensitive components) during transport. This in turn reduces or eliminates the costs and materials associated with a repair process, such as “touch up” paints and repair materials, the energy and space required for the repair process, the amount of resources needed to verify and repair the systems, and the like.

The need for storing packaging material at the client site (particularly with non productive space) may be reduced or fully eliminated, because the integrated protective material will be normally stored internal to or within the machine. Further, the need for a customer to order or procure special packing material at the end of a lease term or when a machine needs to be returned for a repair may be reduced or fully eliminated. These in turn provides environmental benefits by reducing raw material usage in the manufacture of new packing material, and decreasing fuel consumption and emissions associated with transporting the packaging material to the customer.

Another positive result of using integrated packaging materials is a reduction in the disposal of original packing and shipping material, in some cases referred to as dunnage, to landfills or through incineration and a subsequent increase in recycling or reuse. Integrated packaging material also permits a greater opportunity to accumulate and recycle like or similar packaging material when the machine is returned to a refurbishment center, the original manufacturer, or distributor.

In one embodiment, large computing systems and machines such as mainframes and large data storage systems may be adapted for use with integrated shipping materials. Computer system structures are commonly constructed with steel or metal frames that serve as the chassis and support structure for internal electromechanical devices as well as for the attachment of exterior panels. The interior dimension of the frame between supporting members (side to side and top to bottom) often is a recessed open space, which provides room for the placement and storage of the integrated packaging material.

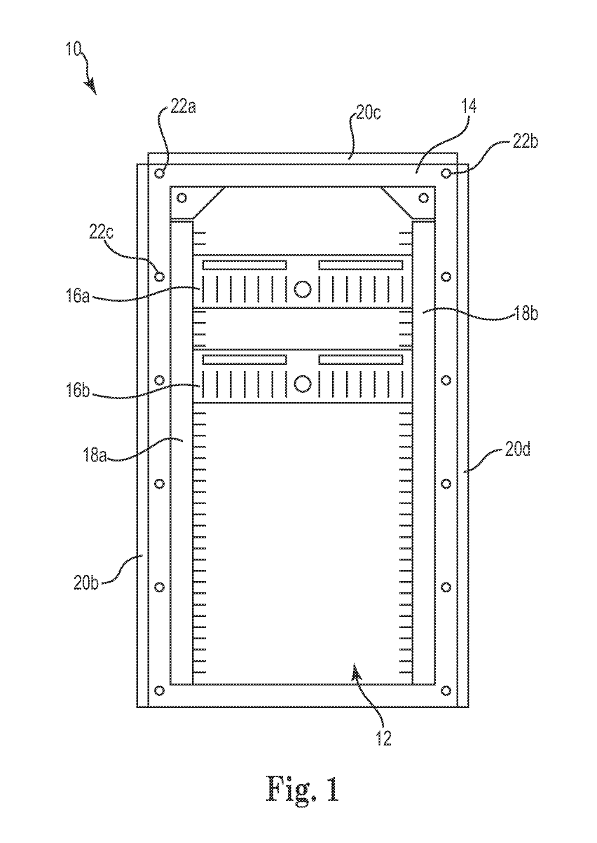

FIG. 1 provides an illustration of a mainframe computer system 10 configured for use with the presently described integrated protective shipping material. As shown, a large interior cavity 12 is defined within the chassis 14 (such as a metal frame structure) of the mainframe. Attached to an interior frame or attachment structure 18a, 18b of the mainframe are a series of subassemblies, printed circuit boards and cards and other computing components 16a, 16b. The mainframe computer system 10 is typically shipped and transported as an entire assembly to a customer, or with a few components and subassemblies being attached on-site. The mainframe computer system 10 further includes a series of aesthetic panel covers 20b, 20c, and 20d mounted to the sides and top of the chassis.

In one specific embodiment, integrated protective packaging or shipping material is coupled to the interior face of a plurality of removable covers or exterior panels used on the machine or object to be transported. These panels may serve as the side, top, or bottom exterior of the machine when placed in a normal upright orientation. The size of the packaging material attached to the panels may be shaped and dimensioned as to nest or reside inside the open space cavity within the frame members when not used for shipping.

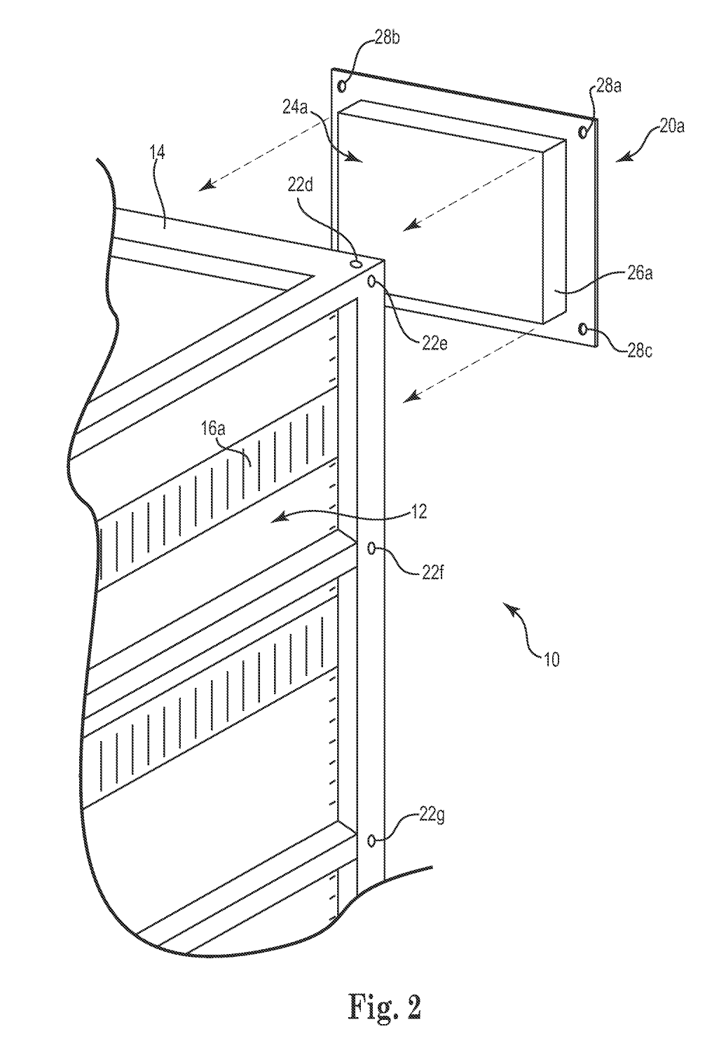

FIG. 2 provides a more detailed illustration of the shape and placement of protective material 24a configured to be inserted within an open cavity 12 of the frame 14 of computing machine 10. As illustrated in FIG. 2, when the machine is in use at the client site, the side cover or panel 20a may be operably coupled to the frame. The protective material 24a faces the interior of the machine and nests within the interior cavity 12 established by the frame 14 and its internal attachment structure 18. The panel 20a may then be attached to the machine frame 12 with use of a fastener extending through panel fastener holes 28a, 28b, 28c into frame fastener receptacles 22a, 22b, 22c respectively (depicted in FIG. 1). Other fastener receptacles 22d, 22e, 22f, and 22g are depicted in FIG. 2 and would receive fasteners for coupling of other panels.

The protective material may serve as a protective barrier or cushion by reversing the panel 20a prior to transport and exposing the protective material 24a external to the machine. However, during most of the lifecycle of the machine, the panel 20a will be positioned with its interior side facing inward, and thus nesting the protective material 24a within the machine.

The protective material 24a is shaped to allow long-term storage within the interior cavity, while not interfering with any electromechanical components within the system that may also reside in the cavity. As shown, the protective material has a defined depth 26a configured for fitting within the frame interior cavity 12. However, a larger dimension of protective material may be compressed, folded, deflated, or otherwise reduced in size in order to fit within the interior cavity 12. In addition to complying with space requirements of the interior cavity 12, the protective material 24a will need to be compatible with the thermal and electrical requirements of the machine it is attached to.

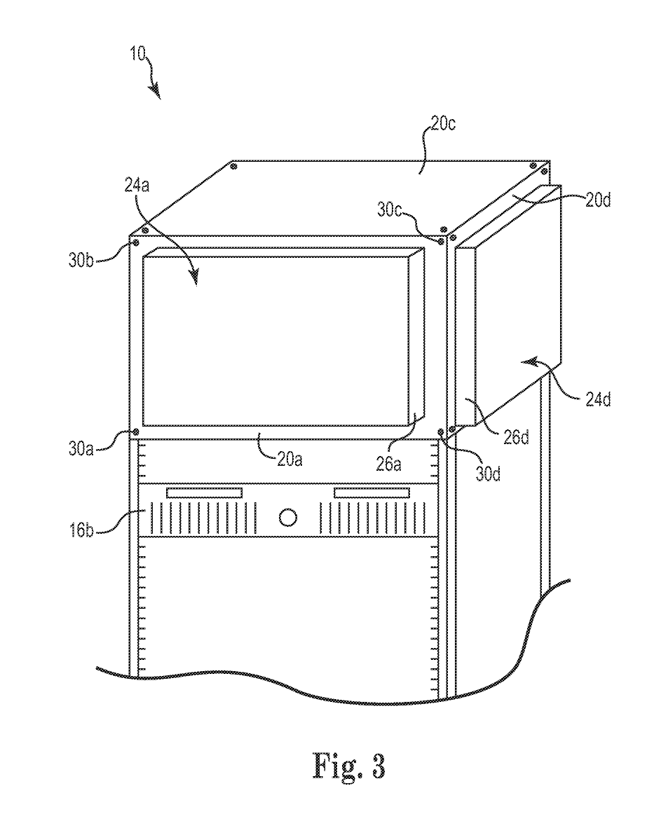

FIG. 3 illustrates a computing server frame having a side panel cover 20a flipped and reattached to the mainframe. This enables the protective material 24a to be exposed externally, and absorb energy with the protective material rather than directly by the object itself. As shown, the side panel 20a is attached to the mainframe (not visible) through use of screws, pins, dowels or the like fasteners at 30a, 30b, 30c, 30d when exposing the panel of protective material 24a. As illustrated, another side panel 20d is attached to the mainframe through similar fasteners, with the side panel 20d exposing another panel of protective material 24d. Likewise, in FIG. 3 another exterior panel 20c of the computing server is attached to the mainframe, although this side of the panel is illustrated without any protective material affixed thereto.

The attachment of the protective material to the first side of a cover or panel may occur by any number of mechanical or adhesion methods. For example, the integrated shipping material may be coupled to the cover through the use of glue, adhesives, or other permanent or semi-permanent bonding agents. Alternately, the protective material and the cover or panel may be coupled with mechanical means to allow easy removal or replacement of the protective material, such as by attaching the protective material to the cover with a series of rails, brackets, or removable fasteners.

As non-limiting examples, the composition of the protective material may fully or substantially comprise foam, expanded polystyrene packaging (generically referred to as “styrofoam”), air pouches or bubbles, rubber, plastic compositions, synthetic or natural padding compositions, or like cushioning materials which absorb the shock and vibration that may occur during transport. As is well known, shock and vibration of objects within a shipping container may occur during movement by commercial transport systems. The protective material is shaped and oriented on the exterior of the machine accordingly to absorb a sizable amount of shock and vibration, and minimize the movement of the underlying structure.

The protective material may also be shaped to comply with certain types of shipping containers. For example, the protective material may be structured to support inclusion of the product in a standard corrugated cardboard box or mailer. The protective material may also be shaped to be supplemented by other packaging materials in the void of the transport container, such as air pouches, peanuts, or loose foam that is kept in stock by the customer.

In one embodiment, the outer L×W×H (length times width times height) dimensions of the protective shipping material must be such that the protective material fully nests within the inner L×W×H dimensions of the connected frame members. The dimensions of the protective material also must not interfere with other product features such as cabling, cooling vents, and normal operation of the machine or object. In a further embodiment, the protective material may be configured to collapse or fold into a smaller configuration for placing in the interior of the machine. The protective material may also be configured to expand or otherwise return to a protective shape or configuration around the product when deployed in a transport setting.

When the machine is prepared for shipping, the side cover or panel may be removed, flipped and reattached to the machine such that the side that is coupled to the protective shipping material is exposed and faces outward. The protective material may be configured to be folded, compressed, or otherwise decreased in linear space or total volume when recessed in the interior cavity of the frame. The protective material may also be configured to expand to a larger surface area around the exterior of the product when removed from the interior cavity. Thus, the protective material may be structured to fold over or otherwise provide protection for frame corners, electronic displays and screens, and other sensitive components of the machine or system that may not have protective material directly attached.

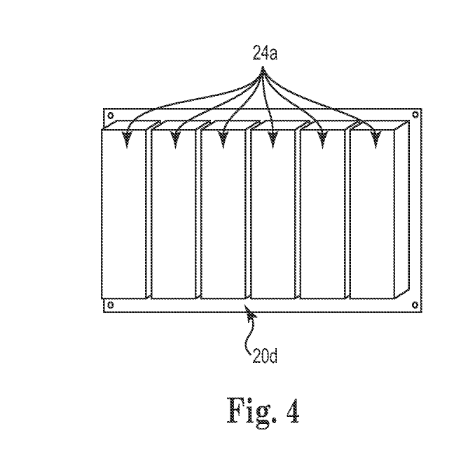

FIG. 4 provides another illustration of a side panel 20a detached from the mainframe computing system. As illustrated within FIG. 4, however, the protective material 24a is not a single member but rather comprises a plurality of protective members strategically located throughout the first side of the side panel. For example, this set of protective members may be “ribbed” to provide a different type of shock absorbency than that of a continuous protective member.

In alternate embodiments, the protective material may be integrated within a machine or other object through the use of removable protective pieces or other structures which are not permanently fixed to the machine or system. For example, a piece of protective foam material may be structured to be easily attached to the exterior of the machine or object, and then removed to be stacked, folded, or nested within an empty portion of the computer system frame. Further, the protective material may be integrated with hinged panels that make deployment of the packaging materials faster and easier. The numerous inflatable and expandable packaging materials that may be used make a wide variety of configurations and designs applicable to the presently described invention.

Although a number of examples provided herein illustrate the use of packaging material within large mainframe computer systems, the presently described integrated packaging materials and techniques may also be employed within computer systems of varying shapes, sizes, and configurations. Moreover, the various features and advantages of the present invention may be applied to other types of objects such as consumer appliances, electronic devices, replacement parts, machines, and other items capable of transport.

For example, a consumer appliance such as a microwave, dishwasher, refrigerator, oven, and the like may use a series of reversible panels or covers with protective material attached to prevent dents, scratches, and other damage during transport. Protective material may be attached only to certain panels that are normally visible (such as the front of a refrigerator or dishwasher), or the protective material may be employed on all or substantially all panels. The protective material may be then hidden into the appliance during the installation of the appliance.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Embodiments were chosen and described in order to best explain the principles of the invention and the practical application, and to enable others of ordinary skill in the art to understand the invention for various embodiments with various modifications as are suited to the particular use contemplated.

Moreover, although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A computer assembly having integrated protective material, comprising:
a frame structured for support of a plurality of computer system components, an exterior of the frame defined by a plurality of support members, and the support members defining an interior cavity within the frame;
a plurality of computer system components coupled to the frame and arranged within at least a portion of the interior cavity of the frame;
at least one reversible cover panel structured for removable coupling to the exterior of the frame, the cover panel defining a first side and an opposing second side; and
a protective material disposed on the first side of each cover panel;
wherein removably coupling the first side of the cover panel to the exterior of the frame positions the protective material entirely within the interior cavity of the frame; and
wherein removably coupling the opposing second side of the cover panel to the exterior of the frame exposes the protective material such that the protective material extends distal to the frame.

2. The computer assembly of claim 1, wherein the protective material is energy-absorbing packaging material comprising one or more of foam, expanded polystyrene foam, rubber, plastic, inflated air bubbles, and inflatable air packets.

3. The computer assembly of claim 1, wherein the packaging material is heat resistant to operating temperatures produced by the computer system components.

4. The computer assembly of claim 1, wherein the protective material is permanently coupled to the first side of the cover panel with an adhesive.

5. The computer assembly of claim 1, wherein the protective material is removably coupled to the first side of the cover panel thereby allowing removal and replacement of the protective material from the first side of the cover panel.

6. The computer assembly of claim 1, wherein the frame comprises a metal frame and the cover panel comprises a metal cover panel.

7. The computer assembly of claim 1, wherein the cover panel is removably coupled to the exterior of the frame with one or more removable fasteners.

8. The computer assembly of claim 1, wherein at least one cover panel providing the protective material is operably coupled to each side of the frame.

9. The computer assembly of claim 1, wherein the protective material disposed on the first side comprises a plurality of protective material members.

10. A product having integrated protective packaging material, comprising:
a product frame defining an internal cavity;
a plurality of reversible covers, each reversible cover structured for removable coupling to the product frame, and each reversible cover defining a first side and an opposing second side;
a protective packaging material disposed on the first side of each reversible cover, an entirety of the protective packaging material dimensioned to fit within the internal cavity of the product frame;
wherein removably coupling the first side of the reversible covers to the exterior of the product frame causes the protective packaging material to be entirely disposed within the internal cavity of the frame and exposes the second side of the reversible covers distally to the frame; and
wherein removably coupling the second side of the reversible covers to the exterior of the product frame causes the protective packaging material to be entirely exposed and extend distal to the product frame.

11. The product of claim 10, wherein the protective packaging material comprises one or more of foam, expanded polystyrene foam, rubber, plastic, inflated air bubbles, and inflatable air packets.

12. The product of claim 10, wherein the protective packaging material is permanently coupled to the first side of the reversible cover.

13. The product of claim 10, wherein the protective packaging material is removably coupled to the first side of the reversible cover to facilitate removal and replacement of the protective packaging material.

14. The product of claim 10, wherein the reversible cover is removably coupled to the exterior of the product frame with one or more removable fasteners.

15. The product of claim 10, wherein at least one cover having the protective material is operably coupled to each side of the product frame.

16. A method for integrating protective packaging material with a product assembly, comprising:
attaching a protective packaging material to a first side of a reversible cover panel, the reversible cover panel configured for mounting to the product assembly, and the reversible cover panel having a second side opposing the first side;
mounting the reversible cover panel to the product assembly such that the first side of the reversible cover panel extends distal to the product assembly, thereby exposing the first side of the reversible cover panel and the protective packaging material attached to the first side of the reversible cover panel;
removing the reversible cover panel from the assembly;
recessing the protective packaging material attached to the first side of the reversible cover panel within an interior cavity of the product assembly; and
mounting the reversible cover panel to the product assembly such that the second side of the reversible cover panel extends distally to the product assembly, thereby exposing the second side of the reversible cover panel.

17. The method of claim 16, wherein the protective packaging material is energy-absorbing and comprises one or more of foam, expanded polystyrene foam, rubber, plastic, inflated air bubbles, and inflatable air packets.

18. The method of claim 16, wherein the protective packaging material is permanently coupled to the first side of the reversible cover panel with an adhesive.

19. The method of claim 16, wherein the protective packaging material is removably coupled to the first side of the reversible cover panel thereby allowing removal and replacement of the protective packaging material from the first side of the reversible cover panel.

20. The method of claim 16, wherein the cover panel is removably coupled to the exterior of the product assembly with one or more removable fasteners.
